(19) United States
(12) Patent Application Publication
(10) Pub. No.: US 2023/0186932 A1
(43) Pub. Date: Jun. 15, 2023

(54) AUDIO INTERFERENCE CANCELLATION

(71) Applicant: Comcast Cable Communications, LLC, Philadelphia, PA (US)

(72) Inventor: Scott KURTZ, Mount Laurel, NJ (US)

(21) Appl. No.: 18/066,713

(22) Filed: Dec. 15, 2022

Related U.S. Application Data
(60) Provisional application No. 63/290,004, filed on Dec. 15, 2021.

(51) Int. Cl. G10L 21/0216; H04R 3/00

(52) U.S. Cl. CPC G10L 21/0216; H04R 3/005; G10L 2021/02166; H04R 2410/01

(57) ABSTRACT

Methods and systems for audio interference cancellation are disclosed. A first beamforming zone associated with a location of a first audio source may be determined. A second beamforming zone associated with a location of a second audio source may be determined. Based on determining that first audio associated with the first audio source dominates a first frequency band associated with the first beamforming zone and the second beamforming zone, prevention of attenuation of audio output in the first beamforming zone and within the first frequency band may be caused. Based on determining that second audio associated with the second audio source dominates a second frequency band associated with the first beamforming zone and the second beamforming zone, attenuation of audio output in the first beamforming zone and within the second frequency band may be caused.

### CROSS-REFERENCE TO RELATED APPLICATIONS

This application claims the benefit of priority of U.S. Provisional Patent Application No. 63/290,004, filed Dec. 15, 2021, and titled “Audio Interference Cancellation,” the content of which is hereby incorporated by reference in its entirety.

### BACKGROUND

Voice-controlled devices may be intended to operate in the proximity of a television and/or other possible audio interference sources. Such interference may negatively impact the performance of such voice-controlled devices. Techniques for mitigating such interference are needed.

### BRIEF DESCRIPTION OF THE DRAWINGS

FIG. 1 shows an example system.

FIG. 2 shows an example system.

FIG. 3 shows an example beamformer gain pattern.

FIG. 4 shows an example system.

FIG. 5 shows an example set of beamformer gain patterns.

FIG. 6 shows an example system.

FIG. 7 shows example relationships between algorithms and conditions.

FIG. 8 shows an example method.

FIG. 9 shows an example computing device.

### DETAILED DESCRIPTION

Voice-controlled devices may be intended to operate in the proximity of a television and/or other possible audio interference sources. Such interference may negatively impact the performance of such voice-controlled devices. Through the use of acoustic echo cancellation, acoustic beamforming, noise reduction, and interference cancellation, the detrimental effects of audio interference on the operation of such voice-controlled devices may be minimized. Such techniques for mitigating audio interference are described herein, with a particular focus on interference cancellation.

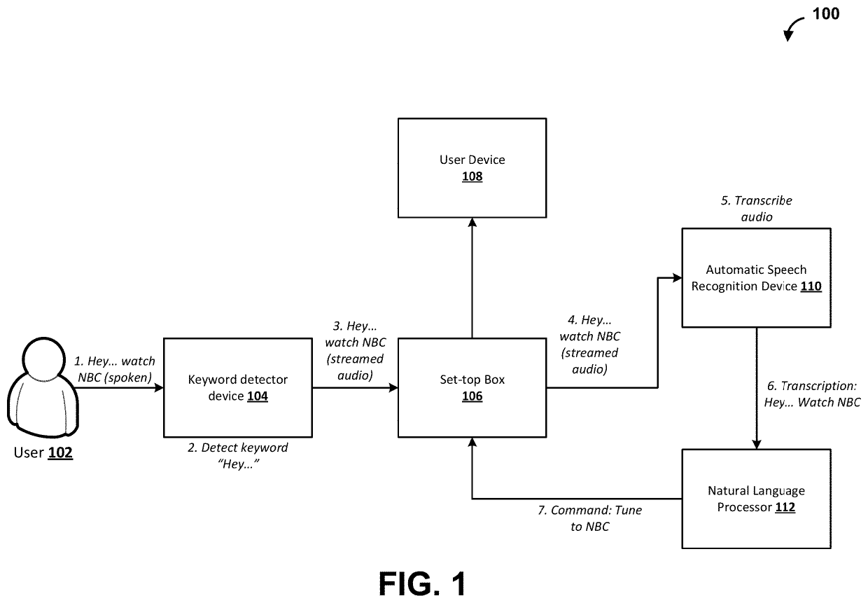

An exemplary system is shown in FIG. 1. The system 100 may comprise a voice-controlled system. The system 100 may comprise a user 102, a keyword detector device 104, a set-top box (STB) 106, a user device 108, an automatic speech recognition device 110, and a natural language processor 112. The user 102 may speak a keyword (e.g., “Hey . . . ”) followed by a command (e.g., “watch NBC”). The keyword may “wake up” a keyword detector device 104 to begin the transaction. The device may comprise (e.g., run) a keyword detector. The keyword detector may be configured to detect the keyword and/or command in the user's speech. Upon detecting the keyword, the keyword detector device 104 may initiate the transaction. The keyword detector device 104, having stored some past audio, begins streaming the keyword audio followed by the spoken command to the STB 106. The STB 106 may be the keyword detector device 104, or may comprise the keyword detector device 104, in which case there may no need for a separate keyword detector device 104. Additionally, or alternatively, the user device 108 (e.g., a television (TV)) may contain the functionality of the STB 106 and/or the keyword detector device 104.

The STB 106 may forward the streamed audio to the automatic speech recognition (ASR) device 110. The ASR device 110 maybe configured to transcribe the keyword and command indicated by the streamed audio into text. The ASR device 110 may send the transcribed text to the Natural Language Processor (NLP) 112. The NLP 112 may be configured to interpret the text. Interpreting the text may comprise determining the user's intent associated with the command. If it is determined that the user's intent is to tune the user device 108 (e.g., the television), the NLP 112 may send the appropriate command to the STB 106. The STB 106 may cause an action to be performed based on the command. For example, the STB 106 may cause the television to be tuned (e.g., to NBC).

Such a process works best when there is little to no audio in the room to interfere with the user 102 issuing the voice command. However, in a TV-centric system, TV audio may be a primary interference source. TV audio may be present more often than not. Other interference sources may include one or more of forced-air HVAC, chatter, home appliances, etc.

Such interference negatively impacts the performance of the system. For example, the user 102 and the user device 108 may be equally distant from the keyword detector device 104. Both the TV audio and user speech may be at the same sound pressure level. The signal to interference ratio as measured at the microphone input to the keyword detector device 104 may be 0 dB. A minimum of 9 dB SNR may be required for the keyword detector (and even higher may be required for the ASR device 110). If the TV audio is louder than the user speech and/or closer to the keyword detector device 104 than the user 102, the SNR may be even worse. Techniques to improve the signal so that the keyword detector device 104 and the ASR device 110 may achieve sufficient accuracy are needed.

Several techniques may help to mitigate such audio interference. For example, one or more of acoustic echo cancellation (AEC), noise reduction, acoustic beamforming, scene analysis, and acoustic interference cancellation may be utilized to mitigate the effects of interfering audio. AEC may be limited to only those situations in which the keyword detector device 104 has access to the TV audio streams for use as an echo canceller reference input.

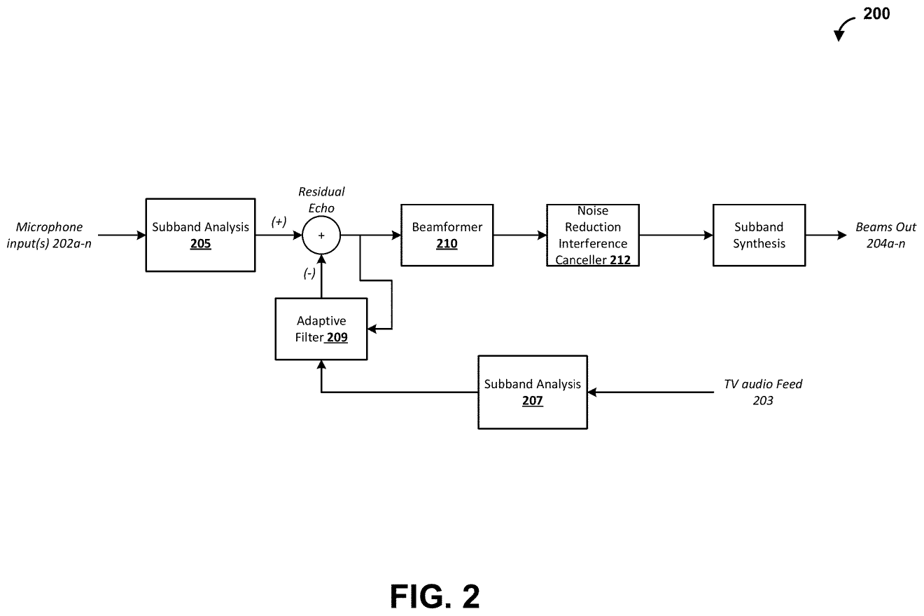

FIG. 2 shows an example system 200. The system 200 may comprise a speech enhancement system. An exemplary speech enhancement algorithm data flow is shown in FIG. 2. As shown on the left side of FIG. 2, one or more microphone inputs 202a-n may be input into the data flow. As shown on the right side of FIG. 2, one or more channels of TV audio 204a-n may be output from the data flow. First, subband analysis may be performed on both the microphone input(s) 202a-n and the TV inputs 203. For example, a subband analysis 205 may be performed on the microphone input(s) 202a-n and a subband analysis 207 may be performed on the TV inputs 203. Performing subband analysis on both the microphone input(s) 202a-n and the TV inputs 203 may comprise decomposing the signal into individual frequency bins. Subband analysis is similar to a fast Fourier transform (FFT), but subband analysis does not suffer from the same boundary issues that an FFT does. The remainder of the processing may be performed in the frequency domain with individual processing performed on each frequency bin.

The first algorithm to be run may be the acoustic echo canceller's adaptive filter 209. The adaptive filter 209 may be configured to predict the echo component of the TV audio that reaches the microphones. The adaptive filter 209 may subtract the predicted echo component off to form a “residual echo” signal. Residual may refer to the portion of the echo that remains unconcealed and therefore bleeds through the adaptive filter 209. Although it is labeled “residual echo,” this signal may be the sum of the residual echo plus the non-TV audio that reaches the microphone input(s) 202a-n. The AEC's adaptive filter 209 may achieve 20 dB or more of echo cancellation.

If there are N microphone input(s) 202a-n, there may also be N residual echo signals emanating from the addition (subtraction) block of the adaptive filter 209. These signals may be fed to an acoustic beamformer 210. The acoustic beamformer 210 may perform spatial filtering. The spatial filtering may makes use of the fact that the TV audio and user speech tend to arrive at the device from different directions. The spatial filter may attenuate the TV while not attenuating the user's speech. The acoustic beamformer 210 is discussed in more detail below.

The acoustic beamformer 210 may comprise multiple types of beamformers. Each beamformer may point in a different direction. Different types of devices may utilize different quantities of beamformers. For example, a standalone hands-free device may utilize four beams each spaced by 90 degrees. For a TV, which tends to be hung on a wall or placed close to a wall, 360 degree coverage is not needed, so three beams may be utilized while still getting 180 degrees of coverage.

The beamformer outputs may be fed to a noise reduction interference canceller 212. The noise reduction interference canceller 212 may perform both stationary noise reduction and interference cancellation. Stationary noise is noise whose spectral characteristics do not change rapidly. Examples of stationary noise may include forced air HVAC, appliance motors. Interference cancellation is another type of spatial filter that may reduce interference beyond what a beamformer alone can do. A 4 mic beamformer may reduce the interference by up to 10 dB depending upon the relative difference in direction of arrival between the user and the interferer. Stationary noise reduction may reduce stationary noise by 6-10 dB independent of the directions of arrival. Interference cancellation may achieve yet another 10 dB or more depending upon directions of arrival.

Referring back to the example in which the TV audio and user speech are at equal sound pressure level and the TV and user are located at equal distances from the keyword detector device 104, without AEC, noise reduction, beamforming, and interference cancellation, the signal to interference ratio is 0 dB. Utilizing AEC, beamforming, and interference cancellation achieves an additional 40 dB of signal-to interference improvement. The 40 dB may not include the noise reduction because the TV audio is not stationary noise.

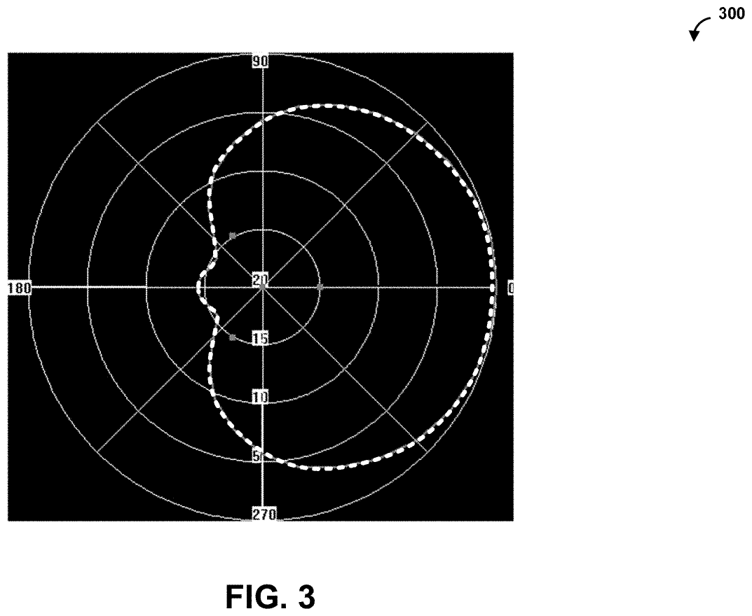

An exemplary beamformer gain pattern 300 is shown in FIG. 3. The outer white circle shown in the beamformer gain pattern 300 may represent a directional gain of 0 dB. Each subsequent smaller circle represents an additional 5 dB of attenuation with respect to the 0 dB reference (outer circle). The beam pattern, represented by the white dashed line, indicates that the maximum gain is achieved in the 0-degree (toward the right, or eastward) direction. At 90 and 270 degrees, there is about 6 dB of attenuation, and at 180 degrees, there is about 15 dB of attenuation. This exemplary beamformer gain pattern 300 is based upon, for example, an anechoic room. The pattern would not be as good if this beamformer were to be used in a room with reflective walls, floor, ceiling, objects, etc. which is the typical use case.

If the keyword detector device 104 were placed in the center of a room, the user were N feet to the right and the TV were N feet to the left (180-degree separation between the two), the output of the beamformer may be such that the TV audio were attenuated by about 15 dB. The user's speech may not be attenuated at all. A 15 dB signal to interference ratio improvement may be achieved. If the TV were instead position at 90 degrees or 270 degrees relative to the user, the improvement may be around 6 dB instead.

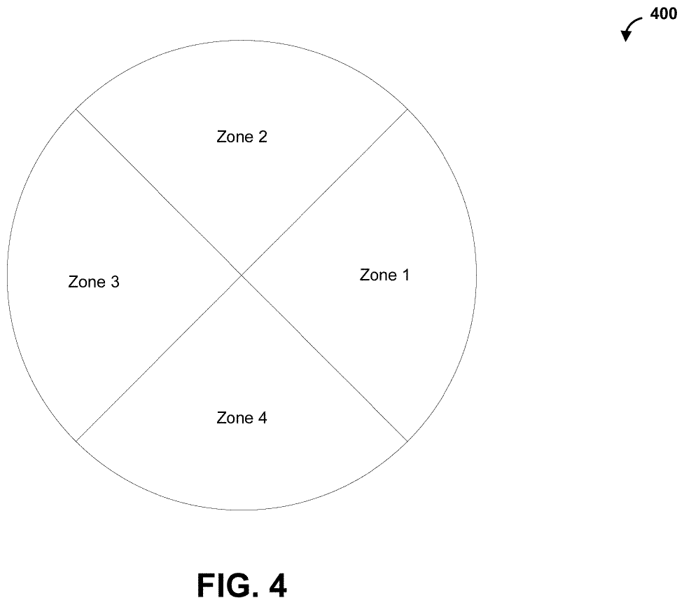

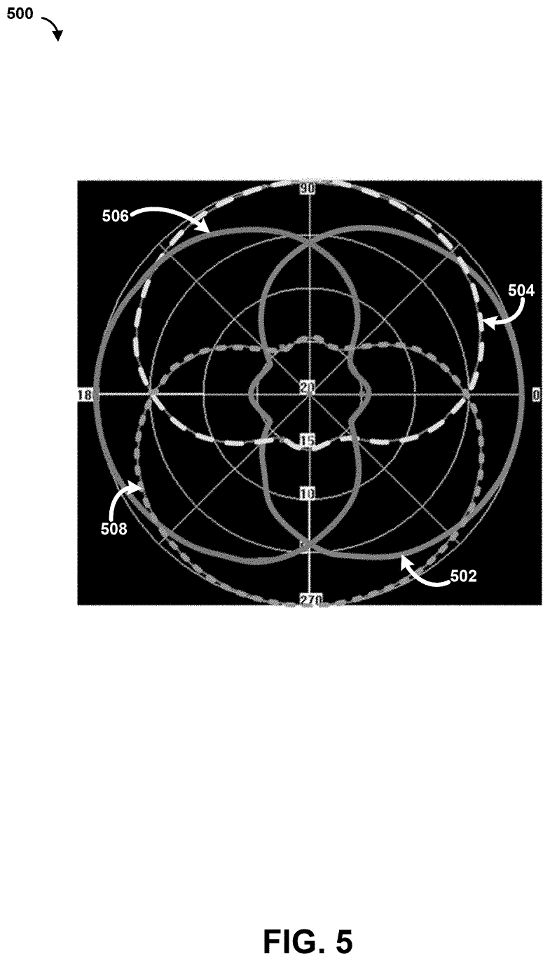

As mentioned previously, the acoustic beamformer 210 may comprise multiple types of beamformers. Each beamformer may point in a different direction. FIG. 4 shows an example system 400. The system 400 may comprise four beams each pointing in a different direction. For example, the system 400 comprises four beamforming zones (e.g., Zones 1-4). Each of the four beamforming zones points in a different direction. Exemplary beam patterns corresponding to the four beamforming zones of FIG. 4 are shown in FIG. 5. The exemplary beamformer gain pattern 500 shown in FIG. 5 comprises four gain plots, with each of the four gain plots corresponding to a particular Zone 1-4 of FIG. 4. For example, the gain plot 502 corresponds to Zone 1, the gain plot 504 corresponds to Zone 2, the gain plot 506 corresponds to Zone 3, and the gain plot 508 corresponds to Zone 4.

An interference canceller may be implemented by comparing the signal level coming out of each of the four beams and applying attenuation based upon what is observed. For example, Zone 1 may have a measured output power level of −25 dB, Zone 2 may have a measured output power level of −16 dB, Zone 3 may have a measured output power level of −10 dB, and Zone 4 may have a measured output power level of −16 dB. These measurements may be expected if there were a single interference source at 180 degrees. If the interference is determined to be the TV audio, Zone 1 may be attenuated 0 degrees, Zone 2 may be attenuated 90 degrees, and Zone 4 may be attenuated 270 degrees based upon the conclusion that the only audio present is due to the TV and it is at 180 degrees (e.g., in Zone 3).

However, if a user is introduced at 0 degrees, the power measurements would no longer reflect only the nature of the beamformer pattern. For example, Zone 1's power would be most greatly affected while the other zones may be affected to a lesser degree. Accordingly, it may be important that Zone 1 is not suppressed anymore. The simple interference canceller may provide little to no benefit. To improve performance, interference cancellation may be performed on narrow subbands in the frequency domain. The user audio may be retained in any frequency band in which there is not also a coincident significant component of the TV audio while audio may be attenuated in frequency bands in which the TV audio is dominant. Dominance is based upon both the measured per-band power in each zone as well as the known beam patterns.

For example, if the TV audio is at 180 degrees and the user is at 0 degrees, the measured output power levels may be as follows: Zone 1 in frequency band A: −10 dB, Zone 1 in frequency band B: −30 dB, Zone 3 in frequency band A: −25 dB, Zone 3 in frequency band B: −15 dB. The measured output power levels indicate that in frequency band A, the user audio dominates because Zone 3 is 15 dB lower than Zone A, which is exactly the amount of attenuation that would be seen there were a single audio source at 0 degrees. Therefore, frequency band A may not be attenuated from Zone 1's beamformer output. For frequency band B, the measured output power levels indicate that the TV audio is dominant because it is 15 dB higher than Zone 1 in that band. Therefore, band B may be suppressed from Zone 1's beamformer.

Additionally, or alternatively, there may be cases where both the user and the TV have significant spectral content in the same band. Depending upon the relative levels, it may be determined that the signal should be left unchanged or attenuated.

The above discussion has been based on the assumptions that the beam gain characteristics would occur in an ideal anechoic room and that the gain is constant at any frequency and direction. However, even in an anechoic room, the latter assumption may be false. Rather, the pattern may be frequency dependent. Additionally, in a room with echo, the pattern may change even more. To further improve interference cancellation in such scenarios, the actual characteristics may need to be learned as a function of frequency in the room in question. This may be part of a “scene analysis.”

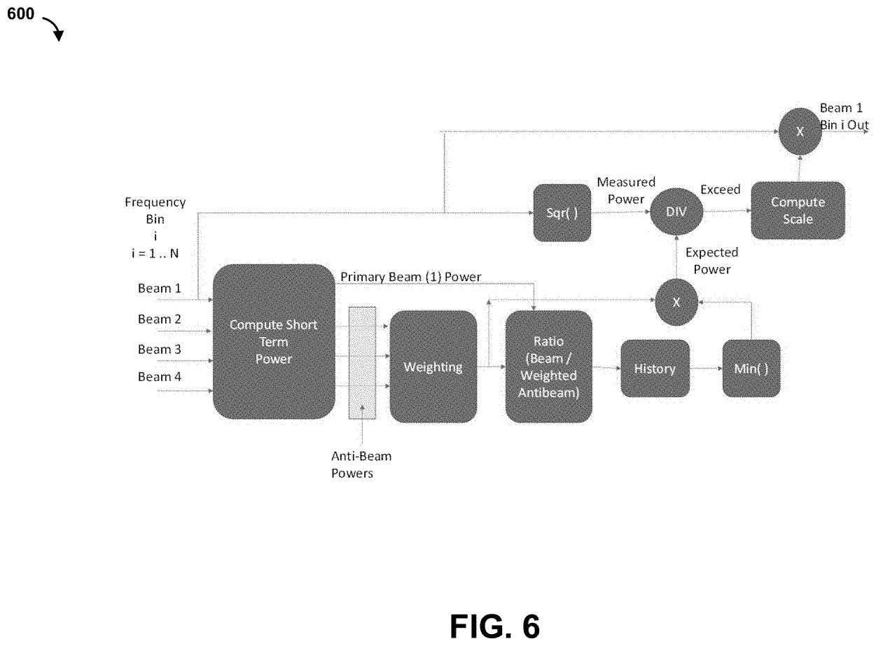

FIG. 6 shows a system 600. The system 600 may comprise or implement an algorithm that may be utilized to characterize a beam pattern. As an example, FIG. 6 shows the processing for a single beam. It may need to be duplicated for each output beam. FIG. 6 shows, for example, the processing for only a single frequency bin. On the left of FIG. 6, four input beams from the beamformer output are shown. FIG. 6 shows the processing that may take place to process a frequency bin to form beam 1's interference canceller output. Similar processing may be performed for all bins for all beams as needed. The only overlap in processing between the beams may occur the first block—“compute short term power.”

At each sub-band frame, each beamformer output may send, to the interference canceller, a single complex sample for each bin. For example, if there are 4 beams and 256 bins per beam, the input to the interference canceller for a single sub-band frame may comprise 4*256 complex samples. The short-term power for each beam/bin may be computed by the Compute Short Term Power block. A “short-term” duration may be, for example, one second. To compute short-term power, a running sum of squares for each beam/bin may be determined over the course of one second. At the end of each second, additional processing may be performed. First, anti-beams for beam 1 may be defined. Defining anti-beams for beam 1 may comprise defining all the beams that are not beam 1 as anti-beams. The short-term powers of the antibeams may be weighted using a set of weighting factors. The opposing beam may be weighted with the greatest weight and the other two beams may be weighted at lesser weights. The weights may be chosen, for example, dynamically based upon the state of the TV and/or based on the results from scene analysis.

The output of the weighting function may be the weighted antibeam short term power. The primary beam's short-term power may be divided by the weighted antibeam short term power. The result may be the ratio between beam 1's power to the weighted antibeam power. If there were only a user at 0 degrees during that 1 second, the resulting ratio would reflect the component of the user's speech in that frequency bin that makes its way into the other beams, considering their respective beam patterns as a function of frequency and taking into account room acoustics. The result may represent the actual beamformer beam pattern (at least at as many data points as there are beams). This may also be part of scene analysis.

However, it may not be guaranteed that the resulting ratio is the correct ratio because during that second. It may be possible that there may have been more than one active audio source. For that reason, the short-term powers may be fed into a (first in, first out or circular) history buffer and the minimum ratio over the course of a longer period of time may be kept track of. If the longer-term period is high enough, the minimum ratio may far better reflect the true ratio when only one audio source is active. This may result in an even better estimate of the beam patterns than the short-term estimate.

The minimum ratio may be multiplied by the current weighted antibeam power to form the expected power emanating from zones associated with the antibeams. The current primary beam power may be divided by the expected antibeam power to form an “Exceed” value. If there is no user speech in the frequency bin in question, it may be expected that the resulting ratio will be 1. If there is user speech that frequency bin, it may be expected that the resulting ratio will be greater than 1. The magnitude of how great the ratio exceeds one may reflect how dominant the user speech is compared with audio in the antibeam zones.

The value by which the ratio exceeds one may be input to a scale predictor which may compute the scale factor that may be applied to the bin in question. If the user audio is very dominant, the scale factor may be 1.0, corresponding to zero attenuation. If the antibeams are dominant, the scale factor may be less than 1.0, corresponding to attenuation. The scale factor may further be subject to a minimum value in order to avoid being overly aggressive. The scale predictor may be modified dynamically based upon the state of the system as well as the results from scene analysis.

Additionally, a number of conditions and events may be kept track of to control the operation of the interference canceller. Such conditions and events may include, for example, TV audio direction of arrival with respect to primary beam, TV audio level, one or more keywords that were detected, TV audio was muted/unmuted, and/or an end of audio stream (resumption of keyword detection).

In particular, the antibeam weighting factors, the scale factor computation block, and the maximum attenuation (minimum scale) setting may be modified based upon these events and characteristics. For example, once the TV zone (beam) is identified, that beam may be the only beam selected for us as an antibeam, rather than use a weighted sum of three beams.

The TV audio direction of arrival may be determined based upon the fact that TV audio is nearly always present. This tends to differ from conversation which may have more gaps and often emanates from different zones in the room. The most active zone may be monitored over a long period of time, and if the activity exceeds a threshold, it may be declared that the TV audio is on in that zone. Similarly, the long-term TV audio level may be measured. The other events may come from other components in the system, including the keyword detector, the TV audio muting mechanism, and the end of speech detector.

This event and scene analysis based algorithm tweaking may result in one more feature of the interference canceller algorithm. Upon the keyword detection event, the beam with the best keyword confidence score (e.g., “best beam”) may be selected. The peak power of the keyword utterance in that beam may be measured. A history of the beam power may be maintained so that it is able to be searched for a peak. During the subsequent period of time, the interference canceller may be modified to be more aggressive by increasing the maximum attenuation and/or making the scale computation more aggressive, based upon the ratio of the peak keyword utterance power to the current beamformer output power.

Scene analysis, signal conditions, and keyword detector confidence score may additionally be utilized to control when and if we choose to mute the TV audio after a keyword has been detected. Under some conditions, it may be desirable to mute the TV audio immediately. Under other conditions, it may be desirable to wait until the cloud has had a chance to verify the presence of a keyword in the streamed audio.

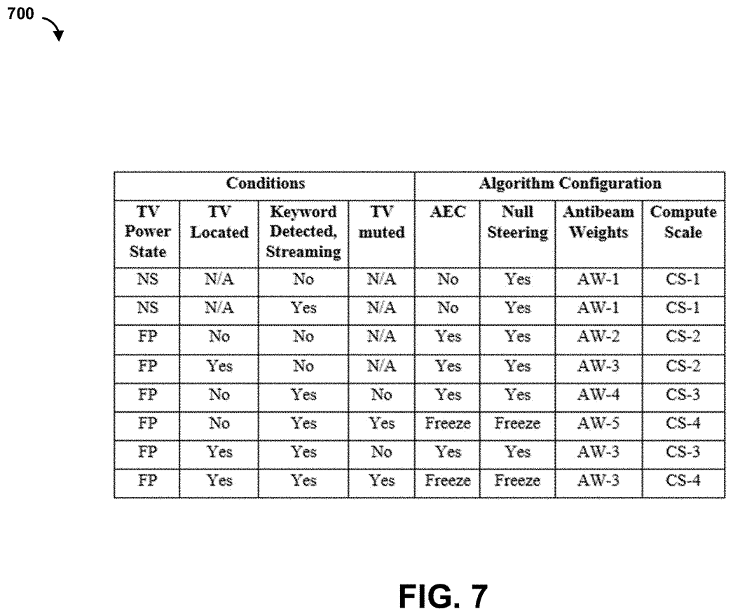

FIG. 7 shows a table 700. The table 700 shows how various algorithms work under various conditions and states. In FIG. 7, NS may indicate Low Power/Networked Standby and FP may indicate Power On/Full Power. AW-N may indicate a set of antibeam weights that is best suited for the combination of conditions. CS-N may indicate a set of Compute Scale parameters including maximum attenuation that are best suited for the combination of conditions. The TV power state may be known (when the far field device is the TV and/or is informed specifically by the TV) or it may be inferred by the far-field device through the use of scene analysis.

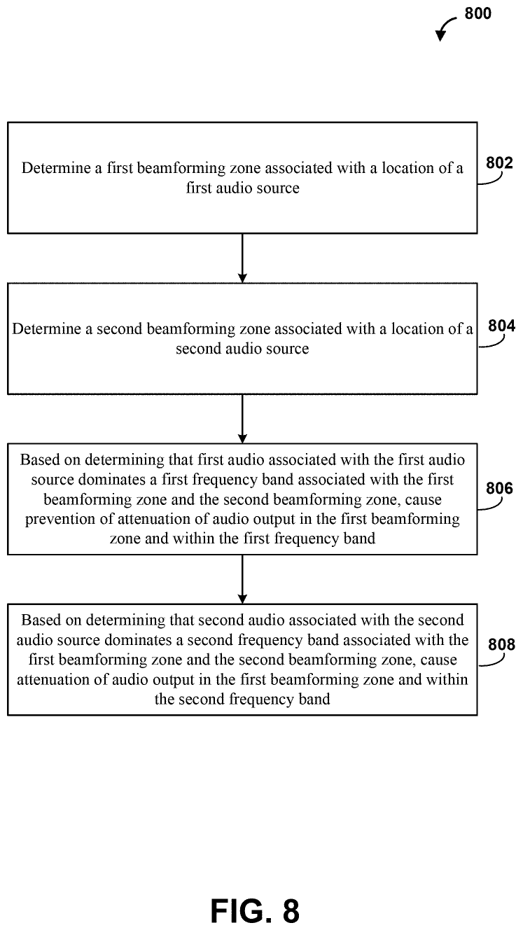

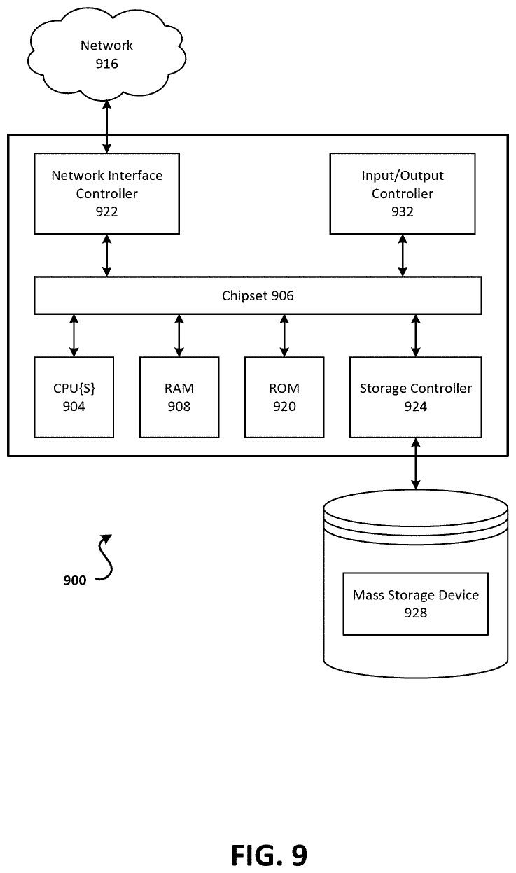

FIG. 8 is a flow diagram illustrating an example method. The method 800 may comprise a computer implemented method for audio interference cancellation. A system and/or computing environment, such as the system 100 of FIG. 1 and/or the computing environment of FIG. 9, may be configured to perform the method 800.

An acoustic beamformer may comprise multiple types of beamformers. Each beamformer may point in a different direction. For example, a beamformer system may comprise four beams each pointing in a different direction. Each of the four beams may be associated with a beamforming zone. Each of the four beamforming zones may point in a different direction.

At 802, a first beamforming zone associated with a location of a first audio source may be determined. A keyword detection device may be located at a center of an area. The first beamforming zone may be associated with a first portion of the area surrounding the keyword detection device. Determining the first beamforming zone associated with the location of the first audio source may comprise determining that the location of the first audio source is located in the first portion of the area surrounding the keyword detection device. The first audio source may comprise a human.

At 804, a second beamforming zone associated with a location of a second audio source may be determined. The second beamforming zone is associated with a second portion of the area surrounding the keyword detection device. Determining the second beamforming zone associated with the location of the second audio source may comprise determining that the location of the second audio source is located in the second portion of the area surrounding the keyword detection device.

The first beamforming zone and the second beamforming zone may both be associated with a first frequency band and a second frequency band. At 806, prevention of attenuation of audio output in the first beamforming zone and within the first frequency band may be caused. The prevention of the attenuation of the audio output in the first beamforming zone and within the first frequency band may be caused based on determining that first audio associated with the first audio source dominates the first frequency band. If the first audio source comprises a human, the first audio may comprise a voice command spoken by the human. The first beamforming zone may be associated with a first measured output power level in the first frequency band. The second beamforming zone may be associated with a second measured output power level in the first frequency band. Determining that the first audio associated with the first audio source dominates the first frequency band may comprise determining that the first measured output power level is greater than the second measured output power level. Causing prevention of attenuation of the audio output in the first beamforming zone and within the first frequency band may comprise retaining (e.g., not suppressing) the first audio in the first frequency band.

At 808, attenuation of audio output in the first beamforming zone and within the second frequency band may be caused. The attenuation of audio output in the first beamforming zone and within the second frequency band may be caused based on determining that second audio associated with the second audio source dominates the second frequency band. The first beamforming zone may be associated with a first measured output power level in the second frequency band. The second beamforming zone may be associated with a second measured output power level in the second frequency band. Determining that the second audio associated with the second audio source dominates the second frequency band may comprise determining that the second measured output level is greater than the first measured output level.

FIG. 9 shows an example computing device that may be used to implement various devices and/or components illustrated and described throughout, such as the devices and/or components depicted in FIG. 1, FIG. 2, and/or FIG. 6. The example computing device shown in FIG. 9 may be a conventional server computer, workstation, desktop computer, laptop, tablet, network appliance, PDA, e-reader, digital cellular phone, or other computing node, and may be utilized to execute any aspects of the computers described herein.

The computing device 900 may comprise a baseboard, or “motherboard,” which is a printed circuit board to which a multitude of components or devices may be connected by way of a system bus or other electrical communication paths. One or more central processing units (CPUs) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 605. The GPU(s) 605 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random access memory (RAM) 908 used as the main memory in the computing device 900. The chipset 906 may further provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems through local area network (LAN) 916. The chipset 906 may include functionality for providing network connectivity through a network interface controller (NIC) 922, such as a gigabit Ethernet adapter. A NIC 922 may be capable of connecting the computing device 900 to other computing nodes over a network 916. It should be appreciated that multiple NICs 922 may be present in the computing device 900, connecting the computing device to other types of networks and remote computer systems.

The computing device 900 may be connected to a mass storage device 928 that provides non-volatile storage for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may further read information from the mass storage device 928 by detecting the physical states or characteristics of one or more particular locations within the physical storage units.

In addition to the mass storage device 928 described above, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 928 depicted in FIG. 6, may store an operating system utilized to control the operation of the computing device 900. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described above. The computing device 900 may have access to computer-readable storage media storing computer-executable instructions, which, when executed by the computing device 900, may perform the methods described in relation to FIG. 5, FIG. 6, and FIG. 7.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components shown in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining a first beamforming zone associated with a location of a first audio source;
determining a second beamforming zone associated with a location of a second audio source;
based on determining that first audio associated with the first audio source dominates a first frequency band associated with the first beamforming zone and the second beamforming zone, causing prevention of attenuation of audio output in the first beamforming zone and within the first frequency band; and
based on determining that second audio associated with the second audio source dominates a second frequency band associated with the first beamforming zone and the second beamforming zone, causing attenuation of audio output in the first beamforming zone and within the second frequency band.

2. The method of claim 1, wherein a keyword detection device is located at a center of an area, the first beamforming zone is associated with a first portion of the area surrounding the keyword detection device, and the second beamforming zone is associated with a second portion of the area surrounding the keyword detection device.

3. The method of claim 2, wherein determining the first beamforming zone associated with the location of the first audio source comprises determining that the location of the first audio source is located in the first portion of the area surrounding the keyword detection device, and
wherein determining the second beamforming zone associated with the location of the second audio source comprises determining that the location of the second audio source is located in the second portion of the area surrounding the keyword detection device.

4. The method of claim 1, wherein the first beamforming zone is associated with a first measured output power level in the first frequency band and the second beamforming zone is associated with a second measured output power level in the first frequency band, and
wherein determining that the first audio associated with the first audio source dominates the first frequency band comprises determining that the first measured output power level is greater than the second measured output power level.

5. The method of claim 1, wherein the first beamforming zone is associated with a first measured output power level in the second frequency band and the second beamforming zone is associated with a second measured output power level in the second frequency band, and
wherein determining that the second audio associated with the second audio source dominates the second frequency band comprises determining that the second measured output level is greater than the first measured output level.

6. The method of claim 1, wherein the first audio source comprises a human and the first audio comprises a voice command spoken by the human.

7. The method of claim 6, further comprising:
causing processing of the audio output in the first beamforming zone and within the first frequency band to determine the voice command.

8. The method of claim 1, wherein causing prevention of attenuation of the audio output in the first beamforming zone and within the first frequency band comprises retaining the first audio in the first frequency band.

9. A computer-readable medium storing instructions that, when executed, cause:
determining a first beamforming zone associated with a location of a first audio source;
determining a second beamforming zone associated with a location of a second audio source;
based on determining that first audio associated with the first audio source dominates a first frequency band associated with the first beamforming zone and the second beamforming zone, causing prevention of attenuation of audio output in the first beamforming zone and within the first frequency band; and
based on determining that second audio associated with the second audio source dominates a second frequency band associated with the first beamforming zone and the second beamforming zone, causing attenuation of audio output in the first beamforming zone and within the second frequency band.

10. The computer-readable medium of claim 9, wherein a keyword detection device is located at a center of an area, the first beamforming zone is associated with a first portion of the area surrounding the keyword detection device, and the second beamforming zone is associated with a second portion of the area surrounding the keyword detection device.

11. The computer-readable medium of claim 10, wherein the instructions, when executed, cause determining the first beamforming zone associated with the location of the first audio source comprise instructions that cause determining that the location of the first audio source is located in the first portion of the area surrounding the keyword detection device, and
wherein the instructions, when executed, cause determining the second beamforming zone associated with the location of the second audio source comprise instructions that cause determining that the location of the second audio source is located in the second portion of the area surrounding the keyword detection device.

12. The computer-readable medium of claim 9, wherein the first beamforming zone is associated with a first measured output power level in the first frequency band and the second beamforming zone is associated with a second measured output power level in the first frequency band, and
wherein the instructions, when executed, cause determining that the first audio associated with the first audio source dominates the first frequency band comprise instructions that cause determining that the first measured output power level is greater than the second measured output power level.

13. The computer-readable medium of claim 9, wherein the first beamforming zone is associated with a first measured output power level in the second frequency band and the second beamforming zone is associated with a second measured output power level in the second frequency band, and
wherein the instructions, when executed, cause determining that the second audio associated with the second audio source dominates the second frequency band comprise instructions that cause determining that the second measured output level is greater than the first measured output level.

14. The computer-readable medium of claim 9, wherein the first audio source comprises a human and the first audio comprises a voice command spoken by the human.

15. The computer-readable medium of claim 14, wherein the instructions, when executed, further cause processing of the audio output in the first beamforming zone and within the first frequency band to determine the voice command.

16. The computer-readable medium of claim 9, wherein the instructions, when executed, cause causing prevention of attenuation of the audio output in the first beamforming zone and within the first frequency band comprise instructions that cause retaining the first audio in the first frequency band.

17. A device comprising:
one or more processors; and
memory storing instructions that, when executed by the one or more processors, cause the device to:
determine a first beamforming zone associated with a location of a first audio source;
determine a second beamforming zone associated with a location of a second audio source;
based on determining that first audio associated with the first audio source dominates a first frequency band associated with the first beamforming zone and the second beamforming zone, cause prevention of attenuation of audio output in the first beamforming zone and within the first frequency band; and
based on determining that second audio associated with the second audio source dominates a second frequency band associated with the first beamforming zone and the second beamforming zone, cause attenuation of audio output in the first beamforming zone and within the second frequency band.

18. The device of claim 17, wherein a keyword detection device is located at a center of an area, the first beamforming zone is associated with a first portion of the area surrounding the keyword detection device, and the second beamforming zone is associated with a second portion of the area surrounding the keyword detection device.

19. The device of claim 18, wherein the instructions that cause the device to determine the first beamforming zone associated with the location of the first audio source cause the device to determine that the location of the first audio source is located in the first portion of the area surrounding the keyword detection device, and
wherein the instructions that cause the device to determine the second beamforming zone associated with the location of the second audio source cause the device to determine that the location of the second audio source is located in the second portion of the area surrounding the keyword detection device.

20. The device of claim 17, wherein the first beamforming zone is associated with a first measured output power level in the first frequency band and the second beamforming zone is associated with a second measured output power level in the first frequency band,
wherein the instructions that cause the device to determine that the first audio associated with the first audio source dominates the first frequency band cause the device to determine that the first measured output power level in the first frequency band is greater than the second measured output power level in the first frequency band,
wherein the first beamforming zone is associated with a first measured output power level in the second frequency band and the second beamforming zone is associated with a second measured output power level in the second frequency band, and
wherein the instructions that cause the device to determine that the second audio associated with the second audio source dominates the second frequency band cause the device to determine that the second measured output level in the second frequency band is greater than the first measured output level in the second frequency band.
